(19) United States
(12) Patent Application Publication
(10) Pub. No.: US 2004/0267759 A1
(43) Pub. Date: Dec. 30, 2004

(54) Multi-medium information providing system and multi-medium information providing method

(76) Inventors: Masahiro Shimizu, Nara (JP); Yoshihiro Izumi, Nara (JP); Hitoshi Nohno, Mie (JP)

Correspondence Address: NIXON & VANDERHYE, PC, 1100 N GLEBE ROAD, 8TH FLOOR, ARLINGTON, VA, 22201-4714, US

(21) Appl. No.: 10/489,169

(22) PCT Filed: Apr. 30, 2003
(86) PCT No.: PCT/JP03/05502

(30) Foreign Application Priority Data
Jul. 10, 2002 (JP) 2002-201550
Feb. 18, 2003 (JP) 2003-040163

(51) Int. Cl. G06F 7/00

(52) U.S. Cl. 707/100

(57) ABSTRACT

A multimedia information provision system, including a first server, a second server and a user terminal connected to one another via an information communication network, for providing, to the user terminal, multimedia information associated with page information input to the user terminal. The user terminal includes a reading section for reading page information from a page. The first server includes a first database storing page information addresses associated with page information, and a retrieval section for retrieving, from the first database, a page information address associated with the page information that has been read by the reading section and transmitted from the user terminal. The second server includes a second database storing multimedia information associated with the page information addresses stored in the first database, and transmits, from the second database to the user terminal, multimedia information associated with the page information address that has been retrieved by the retrieval section and transmitted from the first server.

### TECHNICAL FIELD

The present invention relates to a multimedia information provision system and multimedia information provision method for providing multimedia information to a user.

### BACKGROUND ART

With recent developments in the information technology, it is becoming important even in our daily lives to efficiently obtain latest information. Newspapers, radio, television, etc., are common means to quickly obtain information regarding changes in the state of society, occurrence of incidents, etc.

Particularly, newspapers are widespread in our daily lives. Newspapers carry a large number of articles efficiently on the limited page space. Newspapers have a high portability and can be read during the commute to work or school. Furthermore, newspapers have a high recordability as necessary articles can be clipped out and saved. Moreover, newspapers have other advantages in that they are delivered to the residence of the subscriber, and in that one can easily scan a page and grasp the outline of the articles thereon.

However, newspapers at present are based on text-based explanation, and are more difficult to understand than television broadcast that makes full use of audio and moving images, except for some articles presented with still images (photographs, pictures, charts, etc.). One approach to make newspapers easier to understand may be to present each article with the text and a still image. However, presenting a still image for every article increases the printing cost and increases the number of pages, which may detract from the advantages such as the portability and the scannability.

On the other hand, television broadcast makes full use of audio and moving images, whereby one can obtain information with a strong impact from television broadcast, and the information is easily understood. However, it also has problems in that one cannot view a program repeatedly or one cannot obtain necessary information at a necessary time since what is broadcast is determined unilaterally. Furthermore, it is very difficult to obtain detailed information, e.g., text information, or the like, other than image information.

As an approach to make newspaper articles easier to understand, Japanese Laid-Open Patent Publication No. 7-115474 discloses a multimedia newspaper system for providing audio and/or image information regarding newspaper articles.

In the system disclosed in the publication, each article carried on a newspaper is given a barcode representing publisher identification information that identifies the publisher of the newspaper and article identification information that identifies the article. A communication terminal having a barcode reader for reading the barcode is provided at the residence of the reader of the newspaper. Detailed data regarding the articles of the newspaper is stored at the publisher, and a database from which the data are transmitted to the communication terminal at the reader's residence is provided at the publisher. The reader reads the barcode attached to an article of interest with the barcode reader and transmits the article identification information to the publisher based on the publisher identification information, whereby data regarding the article is transmitted from the database at the publisher to the communication terminal at the reader's residence. As a result, the reader can obtain audio information and/or image information regarding the article of interest.

### PROBLEMS TO BE SOLVED BY THE INVENTION

However, with the system disclosed in Japanese Laid-Open Patent Publication No. 7-115474, supra, audio/image information for all published newspaper articles needs to be provided and stored in the database at the publisher, thereby requiring a very large database capacity.

The present invention has been made in view of the above, and has an object to provide a multimedia information provision system and a multimedia information provision method that can suitably be used in the provision of multimedia information according to page information.

### DISCLOSURE OF THE INVENTION

A multimedia information provision system of the present invention is a multimedia information provision system, including a first server, a second server, and a user terminal connected to one another via an information communication network, for providing, to the user terminal, multimedia information associated with page information input to the user terminal, wherein: the user terminal includes a reading section for reading page information from a page; the first server includes a first database storing page information addresses associated with page information, and a retrieval section for retrieving, from the first database, a page information address associated with the page information that has been read by the reading section and transmitted from the user terminal; and the second server includes a second database storing multimedia information associated with the page information addresses stored in the first database, and transmits, from the second database to the user terminal, multimedia information associated with the page information address that has been retrieved by the retrieval section and transmitted from the first server. Thus, the object set forth above is achieved.

It is preferred that the first server further includes an analysis section for analyzing the page information transmitted from the user terminal to obtain text information, and the retrieval section retrieves the page information address based on the text information obtained by the analysis section.

The user terminal may include a display section for displaying the multimedia information transmitted from the second server.

The reading section provided in the user terminal may be a scanner for scanning the page to read the page information as image information.

In a preferred embodiment, the first server is owned by a newspaper company, the second server is owned by a television station, and the user terminal is owned by a newspaper subscriber; and the reading section provided in the user terminal reads the page information from a page of a newspaper.

The user terminal may include a storage section for saving the multimedia information transmitted from the second server.

The user terminal may include an output section for externally outputting the multimedia information transmitted from the second server.

The second server may transmit, from the second database to the first server, the multimedia information associated with the page information address retrieved by the retrieval section of the first server.

The multimedia information stored in the second database of the second server may include image information and/or audio information.

Another multimedia information provision system of the present invention is a multimedia information provision system, including a first server, a second server and a user terminal connected to one another via an information communication network, for providing multimedia information associated with a newspaper article read by the user terminal to the user terminal, wherein: the user terminal includes a scanner for scanning a page of a newspaper to read image information of the newspaper article; the first server includes an article address database storing article addresses associated with newspaper articles, an analysis section for analyzing the image information that has been read by the scanner and transmitted from the user terminal to obtain text information, and a retrieval section for retrieving, from the article address database, an article address based on the text information obtained by the analysis section; the second server includes a multimedia information database storing multimedia information associated with the article addresses stored in the article address database, and transmits, from the multimedia information database to the user terminal, multimedia information associated with the article address that has been retrieved by the retrieval section and transmitted from the first server; and the user terminal further includes a display section for displaying the multimedia information transmitted from the second server. Thus, the object set forth above is achieved.

In a preferred embodiment, the first server is owned by a newspaper company, the second server is owned by a television station, and the user terminal is owned by a newspaper subscriber.

The multimedia information stored in the multimedia information database of the second server may include image information and/or audio information.

The user terminal may include a transmission/reception section for transmitting/receiving information to/from the first server and the second server; the first server may include a transmission/reception section for transmitting/receiving information to/from the user terminal and the second server; and the second server may include a transmission/reception section for transmitting/receiving information to/from the user terminal and the first server.

A multimedia information provision method of the present invention is a multimedia information provision method, using a first server, a second server and a user terminal connected to one another via an information communication network, for providing, to the user terminal, multimedia information associated with page information input to the user terminal, the method including: a reading step of reading page information from a page, at the user terminal; a retrieval step of retrieving, from a first database storing page information addresses associated with page information, a page information address associated with the page information that has been read in the reading step, at the first server; and a multimedia information transmission step of transmitting, from a second database storing multimedia information associated with the page information addresses stored in the first database to the user terminal, multimedia information associated with the page information address that has been retrieved in the retrieval step, at the second server. Thus, the object set forth above is achieved.

It is preferred that the method further includes an analysis step of analyzing the page information that has been read in the reading step to obtain text information, at the first server; and a page information address is retrieved based on the text information obtained in the analysis step in the retrieval step.

The method may further include a display step of displaying the multimedia information transmitted from the second server, at the user terminal.

### EFFECTS OF THE INVENTION

Thus, the present invention provides a multimedia information provision system and a multimedia information provision method that can suitably be used in the provision of multimedia information according to page information.

In the multimedia information provision system of the present invention, a page information address associated with the page information read by the user terminal is retrieved from the first database of the first server, and multimedia information associated with the retrieved page information address is transmitted from the second database of the second server to the user terminal. Multimedia information associated with page information is provided to the user as described above, whereby it is possible to make the understanding easier by the multimedia information including image information and audio information without detracting from the scannability and the portability of the page information. Moreover, it is not necessary that multimedia information associated with page information is pre-stored in the first database and it is not necessary to ensure a large capacity for the first database, whereby it is possible to desirably provide multimedia information according to page information. The present invention is particularly suitable for a case where it is not necessary to newly (specially) prepare multimedia information associated with each page information address, i.e., multimedia information associated with page information.

### BRIEF DESCRIPTION OF THE DRAWINGS

FIG. 1 is a diagram schematically illustrating a multimedia information provision system 100 according to an embodiment of the present invention.

FIG. 2 is a flow chart illustrating a multimedia information provision method using the multimedia information provision system 100.

FIG. 3 is a block diagram schematically illustrating a user terminal 30 provided in the multimedia information provision system 100.

FIG. 4 is a block diagram schematically illustrating a first server 10 provided in the multimedia information provision system 100.

FIG. 5 is a block diagram schematically illustrating a second server 20 provided in the multimedia information provision system 100.

FIG. 6 is a flow chart illustrating a billing method that can be used when providing multimedia information by using the multimedia information provision system 100.

FIG. 7 is a flow chart illustrating the data flow for the user terminal 30 at a subscriber's residence

FIG. 8 is a flow chart illustrating the data flow for the first server 10 at a newspaper company.

FIG. 9 is a flow chart illustrating the data flow for the second server 20 at a television station.

FIG. 10 is a flow chart illustrating another billing method that can be used when providing multimedia information by using the multimedia information provision system 100.

FIG. 11 is a cross-sectional view schematically illustrating a portion corresponding to one pixel of a display device 200 that can suitably be used as the user terminal 30.

FIG. 12 is a plan view schematically illustrating a portion corresponding to one pixel of the display device 200.

FIG. 13 is a table showing samples of combinations of owners of the first server, the second server and the user terminal, and types of multimedia information.

### BEST MODE FOR CARRYING OUT THE INVENTION

Embodiments of the present invention will now be described with reference to the drawings. Note that while an embodiment where the multimedia information provision system and the multimedia information provision method of the present invention are applied to newspaper articles will be described, the present invention is not limited to the following embodiment.

Embodiment 1

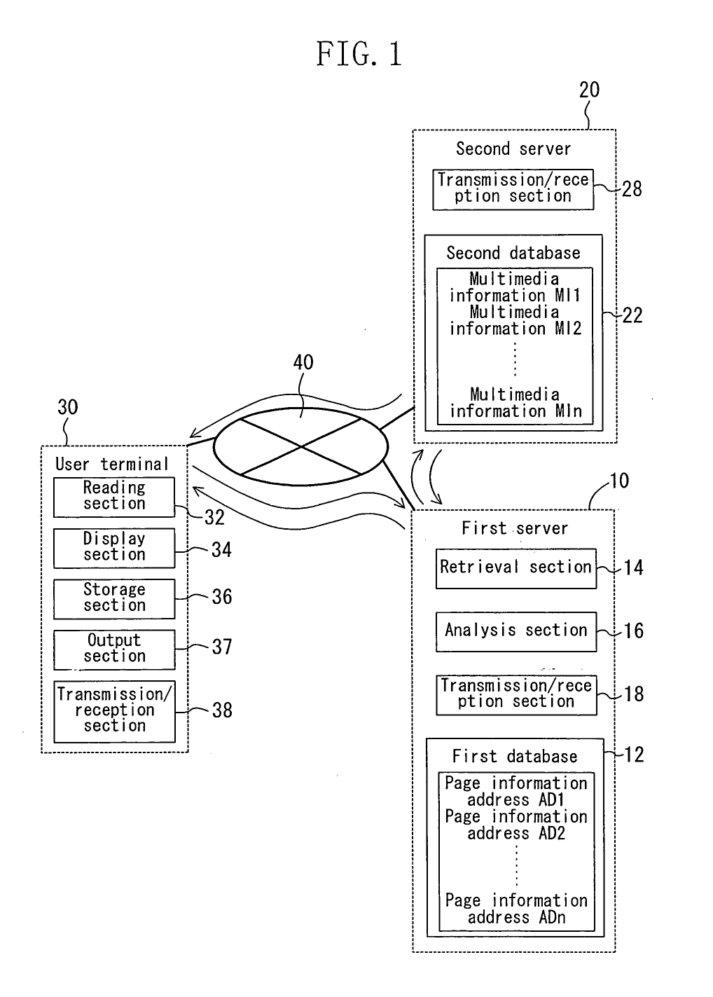

First, the configuration of a multimedia information provision system 100 of an embodiment of the present invention will be described with reference to FIG. 1. FIG. 1 is a diagram schematically illustrating the multimedia information provision system 100.

The multimedia information provision system 100 includes a first server 10, a second server 20 and a user terminal 30 connected to one another via an information communication network 40, and provides multimedia information to the user (user terminal) according to the page information input to the user terminal 30. The information communication network 40 is the Internet, for example, and the multimedia information transmitted/received via the information communication network 40 typically includes image information and/or audio information. Note that a case where the first server 10 is owned by a newspaper company, the second server 20 is owned by a television station, and the user terminal 30 is owned by a newspaper subscriber will be described herein.

The user terminal 30 includes a reading section 32 for reading the page information from a page. Herein, the user terminal 30 is owned by the newspaper subscriber, and the reading section 32 reads the page information (i.e., a newspaper article) from a page of the newspaper. The reading section 32 is, for example, a scanner that scans (typically, scans optically) the page to read the page information as image information. Of course, an electronic component (e.g., an IC chip) or a barcode including information for identifying the page information may be provided on the page in advance, and a device capable of reading information therefrom (e.g., a barcode reader) may be used as the reading section 32. When a scanner is used as the reading section 32, it is not necessary that an electronic component or a barcode is provided on the page in advance, whereby it is possible to reduce the cost therefor and to efficiently use the limited page space. A preferred embodiment of the user terminal 30 will be described later.

The first server 10 includes a first database 12 and a retrieval section 14. In the present embodiment, the first server 10 further includes an analysis section 16. The first server 10 is typically a computer.

The first database 12 stores page information addresses AD1 to ADn associated with page information. A page information address is an identifier indicating a position (storage location) in a second database 22 to be described later of the multimedia information associated with the read page information. The first database 12 is obtained typically by storing page information addresses in a storage device such as a hard disk drive. Moreover, the first database 12 herein is an article address database storing article addresses associated with newspaper articles.

The retrieval section 14 retrieves, from the first database 12, a page information address associated with the page information that has been read by the reading section 32 and transmitted from the user terminal 30. In the present embodiment, the first server 10 includes the analysis section 16 for analyzing the page information transmitted from the user terminal 30 to obtain text information, and the retrieval section 14 retrieves the page information address based on the text information obtained by the analysis section 16. More specifically, the retrieval section 14 retrieves the page information address by, for example, associative retrieval based on the text information. That is, the retrieval section 1.4 associates the text information with the information contents, thereby identifying the storage location.

The second server 20 includes the second database 22 storing multimedia information MI1 to MIn associated respectively with the page information addresses AD1 to ADn stored in the first database 12. The multimedia information typically includes image information and/or audio information, and the image information is moving image information and/or still image information. The second database 22 typically stores the multimedia information in a storage device (preferably, a high-capacity storage device) such as a hard disk drive. Moreover, the second database 22 herein is a multimedia information database storing multimedia information associated with article addresses stored in the article address database.

The second server 20 transmits, from the second database 22 to the user terminal 30, multimedia information associated with the page information address (article address) that has been retrieved by the retrieval section 14 and transmitted from the first server 10. The multimedia information may be transmitted from the second server 20 to the user terminal 30 either directly or indirectly. Where it is transmitted indirectly, it may be transmitted from the second server 20 to the user terminal 30 via the first server 10, for example. That is, the second server 20 may first transmit the multimedia information to the first server 10, and the first server 10 may then transmit the multimedia information to the user terminal 30. Alternatively, the second server 20 may transmit the multimedia information both to the first server 10 and to the user terminal 30 at the same time.

The user terminal 30, to which the multimedia information is transmitted, herein includes a display section 34, a storage section 36 and an output section 37.

The display section 34 displays the multimedia information transmitted from the second server 20. The display section 34 may be, for example, a flat display panel such as a liquid crystal display device or a CRT.

The storage section 36 saves (stores) the multimedia information. The storage section 36 may be a storage device such as a memory or a hard disk drive.

The output section 37 externally outputs the multimedia information. The output section 37 may electrically output the multimedia information to an external device or an external recording medium, or may output the image information included in the multimedia information by printing it on paper.

Note that while the user terminal 30 herein includes the display section 34, the storage section 36 and the output section 37, they may alternatively be omitted. Note however that it is preferred that a component through which the user can make any use of the multimedia information is provided, and it is preferred that at least one of the display section 34 and the output section 37 is provided. Moreover, the user terminal 30 may include an audio output section (e.g., a loudspeaker) for outputting audio information included in the multimedia information, instead of the display section 34, or in addition to the display section 34.

Moreover, the first server 10, the second server 20 and the user terminal 30 typically include a transmission/reception section 18 for transmitting/receiving information to/from the user terminal 30 and the second server 20, a transmission/reception section 28 for transmitting/receiving information to/from the user terminal 30 and the first server 10, and a transmission/reception section 38 for transmitting/receiving information to/from the first server 10 and the second server 20, respectively, thereby allowing for transmission/reception of information therebetween.

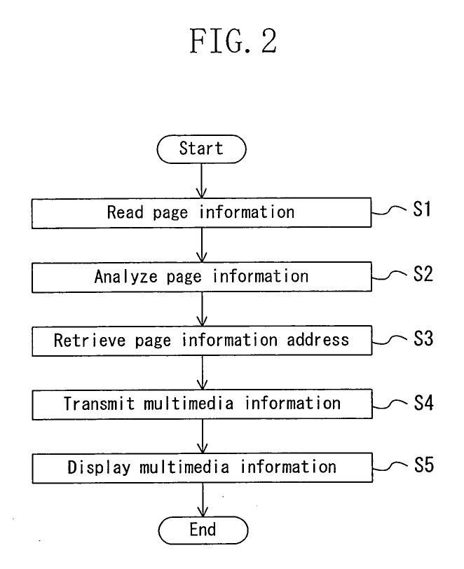

Next, a flow of the multimedia information provision system 100 will be described with reference to FIG. 2. FIG. 2 is a flow chart illustrating a flow of the multimedia information provision system 100 as described above, i.e., a multimedia information provision method using the multimedia information provision system 100.

First, in the user terminal 30, page information is read from a page (reading step S1).

Next, in the first server 10, the page information read in reading step S1 is analyzed to obtain text information (analysis step S2).

Then, in the first server 10, a page information address associated with the page information read in reading step S1 is retrieved from the first database 12 (retrieval step S3). In this step, the page information address is retrieved based on the text information obtained in analysis step S2.

Then, in the second server 20, multimedia information associated with the page information address retrieved in retrieval step S3 is transmitted from the second database 22 to the user terminal 30 (multimedia information transmission step S4).

Finally, in the user terminal 30, the multimedia information transmitted from the second server 20 is displayed (display step S5).

Note that if the page information read by the user terminal 30 does not require an analysis, analysis step S2 may be omitted. For example, when the user terminal 30 includes a barcode reader as the reading section 32, information for identifying page information of a page can be read from a barcode attached to the page, and a page information address can be retrieved based on the information.

Moreover, when the user terminal 30 includes the storage section 36 as illustrated in FIG. 1, there may be provided a saving step of saving (storing) multimedia information transmitted from the second server 20 in the user terminal 30.

Furthermore, when the user terminal 30 includes the output section 37, there may be provided an output step of externally outputting multimedia information transmitted from the second server 20 from the user terminal 30.

Moreover, when the user terminal 30 includes the audio output section, there may be provided an audio output step of outputting audio information included in multimedia information.

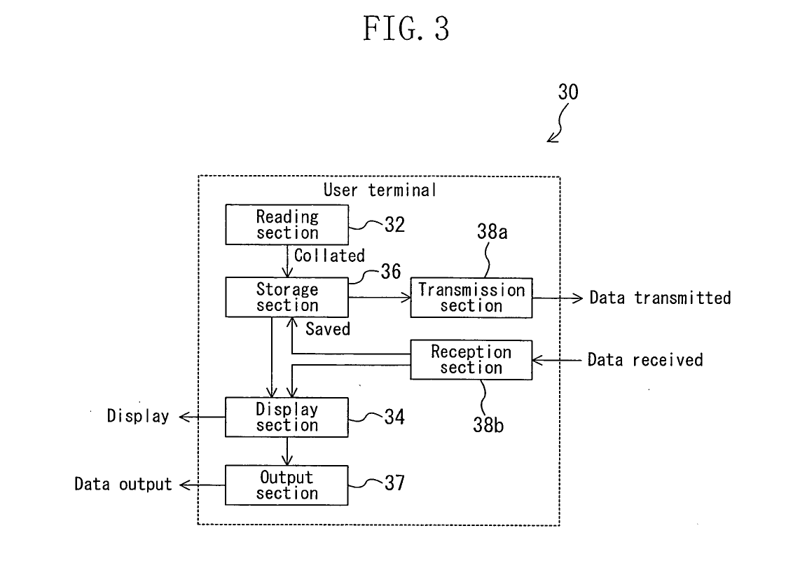

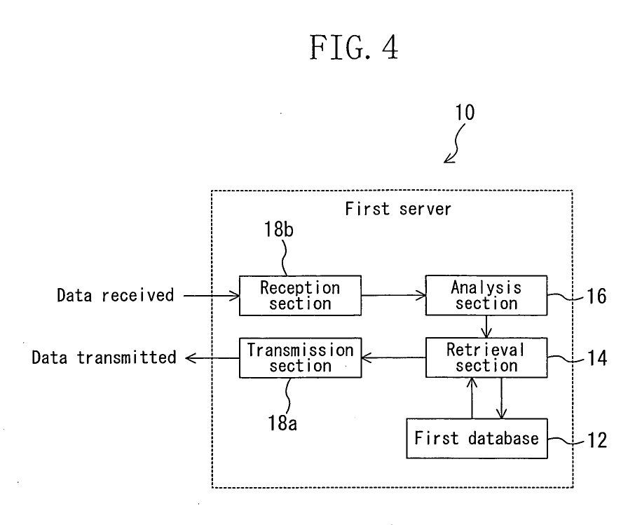

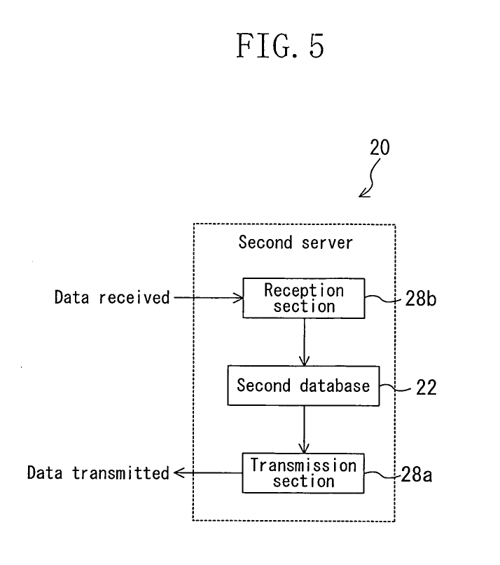

Next, an example of the relationship between components of the user terminal 30, the first server 10 and the second server 20 and the flow of data (information) therein will be described with reference to FIG. 3, FIG. 4 and FIG. 5. Note that the transmission/reception sections 18, 28 and 38 illustrated in FIG. 1 are shown in FIG. 3, FIG. 4 and FIG. 5 as a transmission section 18a and a reception section 18b, a transmission section 28a and a reception section 28b, and a transmission section 38a and a reception section 38b, respectively.

First, an example of the relationship between components of the user terminal 30 and the flow of data therein will be described with reference to FIG. 3. First, page information is read by the reading section 32, and then collated with the multimedia information saved in the storage section 36. When multimedia information associated with the page information is not saved in the storage section 36, data (page information) is transmitted from the transmission section 38a to the first server 10, and data (multimedia information) from the second server 20 is received at the reception section 38b. The received data is displayed on the display section 34 and output from the output section 37 while being saved in the storage section 36. On the other hand, if it is determined, when the page information read by the reading section 32 is collated with multimedia information saved in the storage section 36, that multimedia information associated with the page information is already saved in the storage section 36, the multimedia information is displayed on the display section 34 and output from the output section 37, without transmitting/receiving data to/from the first server 10 and the second server 20.

Next, the first server 10 will be described with reference to FIG. 4. First, data (page information) from the user terminal 30 is received at the reception section 18b. Next, the received data is analyzed by the analysis section 16 to obtain text information. Then, the retrieval section 14 retrieves page information address associated with the page information from the first database 12 based on the analyzed text information. Then, the retrieved page information address (data) is transmitted from the transmission section 18a to the second server 20.

Next, the second server 20 will be described with reference to FIG. 5. First, data (page information address) from the first server 10 is received at the reception section 28b. Next, multimedia information (data) associated with the received page information address is transmitted from the second database 22 to the user terminal 30 via the transmission section 28a.

As described above, in the multimedia information provision system 100 of the present invention, page information address associated with page information read by the user terminal 30 is retrieved from the first database 12 of the first server 10, and multimedia information associated with the retrieved page information address is transmitted from the second database 22 of the second server 20 to the user terminal 30. Multimedia information associated with page information is provided to the user as described above, whereby it is possible to make the understanding easier by the multimedia information including image information and audio information without detracting from the scannability and the portability of the page information. Moreover, it is not necessary that multimedia information associated with page information is pre-stored in the first database 12 and it is not necessary to ensure a large capacity for the first database 12, whereby it is possible to desirably provide multimedia information according to page information.

The present invention can suitably be used in a case where it is not necessary to newly (specially) prepare multimedia information associated with each page information address, i.e., multimedia information associated with page information. For example, the present invention can suitably be used in a case where the first server 10 is owned by a newspaper company, the second server 20 is owned by a television station, and the user terminal 30 is owned by a newspaper subscriber, as in the present embodiment. It is often the case that a television station already has multimedia information associated with newspaper articles. Therefore, it is not necessary to newly prepare multimedia information associated with page information. Thus, it is possible to reduce the cost of preparing multimedia information. Moreover, it is often the case that a television station already has multimedia information associated with newspaper articles at the time when a newspaper is delivered to the user. Therefore, multimedia information associated with page information can be provided immediately. Note that while a case where there is only one second server 20 has been illustrated in the description above, there may be a plurality of second servers 20, which may be owned by a plurality of television stations.

When the user terminal 30 includes the display section 34, the user can make use of the provided multimedia information by displaying it. Moreover, when the user terminal 30 includes the audio output section, the user can make use of audio information included in multimedia information by outputting it.

When the user terminal 30 includes the storage section 36, multimedia information can be saved (stored), whereby it is possible to use the same multimedia information repeatedly without having to access the network again. Moreover, when the user terminal 30 includes the output section 37, multimedia information can be externally output, whereby the multimedia information can be displayed or saved with separate equipment.

With the configuration where the first server 10 includes the analysis section 16 for analyzing page information transmitted from the user terminal 30 to obtain text information and the retrieval section 14 retrieves a page information address based on the text information obtained by the analysis section 16, it is not necessary that information for identifying page information is attached to a page in advance, whereby it is possible to reduce the cost of attaching such information to the page and to efficiently use the limited page space. Such a configuration as described above can easily be realized by, for example, using a scanner as the reading section 32. Note that similar effects can be obtained with a configuration where the analysis section is included in the user terminal 30. However, there are typically a large number of user terminals 30 for one first server 10. Therefore, by employing a configuration where the analysis section 16 is included in the first server 10 as in the present embodiment, it is possible to simplify the overall system configuration.

As already described above, the second server 20 may transmit multimedia information to the first server 10. In such a case, the first server 10 may store the multimedia information therein so that when the user requests the same multimedia information, the multimedia information can be provided to the user without having to access the second server 20. Thus, in a case where the same multimedia information is requested by a large number of users, it is possible to significantly reduce the number of times the information communication network is accessed, thus reducing the load on the information communication network.

Next, a billing method that can be used when providing multimedia information by using the multimedia information provision system 100 of the present invention will be described. A case where the first server 10 is owned by a newspaper company and the second server 20 is owned by a television station will be described in the following description.

First, a possible billing method is a method where the user, i.e., a newspaper subscriber, makes a contract with the newspaper company and pays a rate to the newspaper company, while the newspaper company makes a contract with the television station and pays a rate to the television station.

In such a case, specifically, the newspaper subscriber pays the rate to the newspaper company in one of methods (1) to (3) below, for example.

(1) Pays a fixed rate irrespective of the amount of information.

(2) Pays a predetermined rate at the time of making the contract and pays an additional rate according to the amount of information (e.g., 10 yen per 100 Mbits).

(3) Pays a rate according to the amount of information. Typically, the rate paid per unit amount of information is higher than that in the case (2) (e.g., 20 yen per 100 Mbits).

Moreover, the newspaper company may pay a rate to the television station in one of the methods (1) to (3) described above, or may share the rate paid by the subscriber with the television station at a predetermined ratio (e.g., 1:1).

Moreover, another possible billing method is a method where the newspaper subscriber makes a contract with the newspaper company and with the television station, and pays a rate both to the newspaper company and to the television station.

In such a case, the newspaper subscriber pays a rate in one of the methods (1) to (3) described above. Specifically, the newspaper subscriber pays a rate to the newspaper company and to the television station in one of the following methods (i) to (iii). (i) The total rate paid by the subscriber is shared by the newspaper company and the television station at a predetermined ratio (the cases (1) to (3)).

(ii) The subscriber pays a predetermined rate to the newspaper company at the time of making the contract and further pays an additional rate according to the amount of information to the television station (the case (2)).

(iii) The predetermined rate paid by the subscriber at the time of making the contract is shared by the newspaper company and the television station at a predetermined ratio, and the subscriber further pays an additional rate according to the amount of information to the television station (the case (2)).

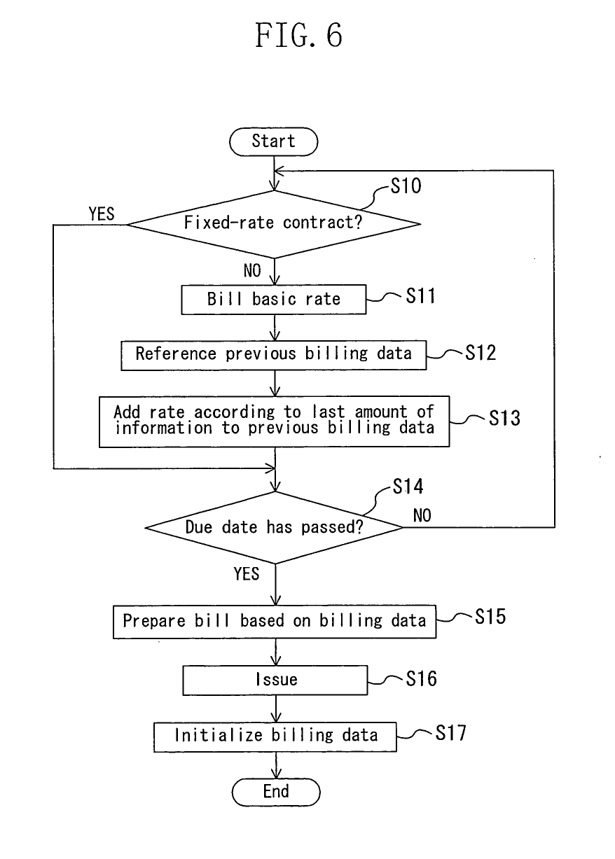

FIG. 6 illustrates the flow of an example of the billing method. When multimedia information is provided to the user, it is first determined whether or not the contract is a fixed-rate contract (the case (1) above) (S10). If it is not a fixed-rate contract, a basic rate is billed (S11) and the previous billing data is referenced (S12), after which a rate according to the last amount of information provided is added to the previous billing data (S13). Next, it is determined whether or not the billing due date has passed (S14). Note that the determination whether or not the billing due date has passed is made (S14) even if it is determined that the contract is a fixed-rate contract (S10).

If the billing due date has passed, a bill is prepared based on the billing data (S15) and the bill is issued (S16), after which the billing data is initialized (S17). On the other hand, if the billing due date has not passed, the process returns to step S10 of determining whether or not the contract is a fixed-rate contract.

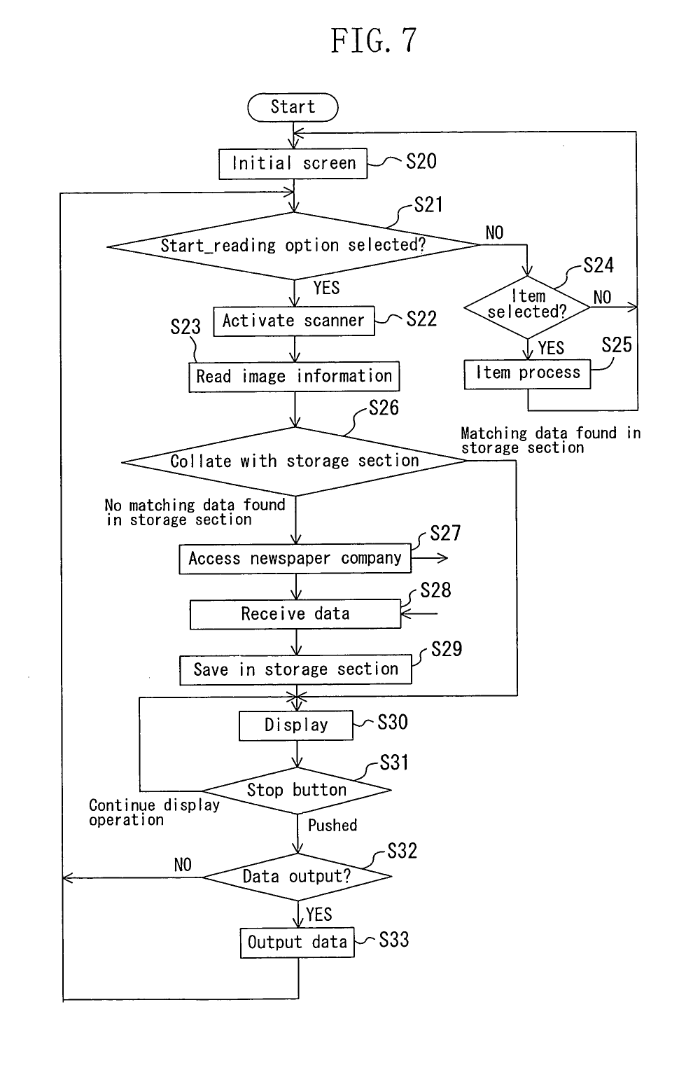

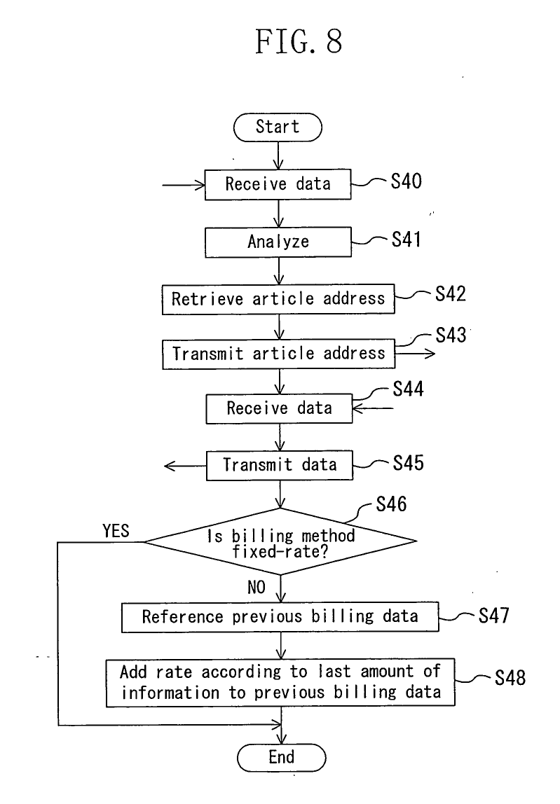

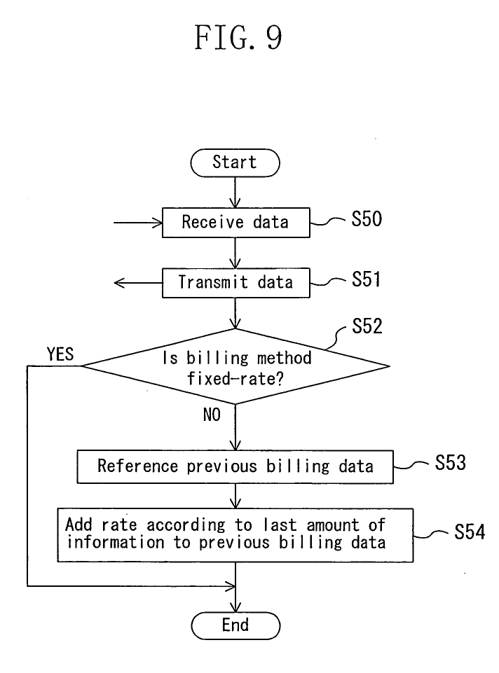

Now, the data flow, including the flow of the billing method, will be described for the user terminal 30 at the subscriber's residence, the first server 10 at the newspaper company and the second server 20 at the television station, with reference to FIG. 7, FIG. 8 and FIG. 9. Note that a case where the user terminal 30 includes a scanner as the reading section 32 will be described.

First, the data flow for the user terminal 30 at the subscriber's residence will be described with reference to FIG. 7.

At first, an initial screen is displayed on the display section 34 (S20). When the start_reading option is selected (S21), the scanner is activated (S22) to read the image information of a newspaper article (S23). Note that if the start_reading option is not selected, it is then determined whether items are selected or not selected (S24). If an item is selected, the process of the selected item is performed (S25), and if no item is selected, the process returns to the initial state (S20). An item to be selected may be, for example, displaying or outputting previously obtained data, managing previously obtained data (retrieval or deletion of data saved in the storage section 36), displaying the billing information, etc.

After the image information is read (S23), it is collated with data (multimedia information) saved in the storage section 36 (S26). If no data associated with the image information is saved in the storage section 36, the terminal accesses the newspaper company (the first server 10 at the newspaper company) to transmit the data (image information) to the newspaper company (S27). Then, data (multimedia information) is received from the television station (the second server 20 at the television station) (S28), and the received data is saved in the storage section 36 (S29).

Then, the data (moving image data or still image data) from the television station is displayed on the display section 34 (S30). Note that if it is determined in the image information collation step (S26) that data associated with the image information is already saved in the storage section 36, the data is displayed without transmitting/receiving data to/from the newspaper company or the television station.

The display operation continues until a stop button is pressed. When the stop button is pressed (S31), the user selects whether or not to output the data (S32). If the user selects to output the data, the data is externally output from the output section 37 (S33), after which the process returns to the initial state (S20). Also when the user selects not to output the data, the process returns to the initial state (S20).

Next, the data flow for the first server 10 at the newspaper company will be described with reference to FIG. 8. A case where multimedia information from the television station is transmitted to the user terminal 30 at the subscriber's residence via the newspaper company is illustrated.

First, data (image information) is received from the user terminal 30 at the subscriber's residence (S40), and the received data is analyzed by the analysis section 16 to obtain text information (S41).

Then, the retrieval section 14 retrieves an article address associated with the image information from the article address database (the first database 12) based on the analyzed text information (S42), and the retrieved article address is transmitted to the television station (the second server 20 at the television station) (S43).

Then, multimedia information (data) is received from the multimedia information database (the second database 22) of the second server 20 at the television station (S44), and the multimedia information is transmitted to the user terminal 30 at the subscriber's residence (S45).

Then, it is determined whether or not the contract is a fixed-rate contract (S46). If it is not a fixed-rate contract, the previous billing data is referenced (S47), after which a rate according to the last amount of information provided is added to the previous billing data (S48). If it is determined that the contract is a fixed-rate contract, the process directly goes to end.

Next, the data flow for the second server 20 at the television station will be described with reference to FIG. 9.

First, data (article address) is received from the first server 10 at the newspaper company (S50). Next, multimedia information (data) associated with the received article address is transmitted from the multimedia information database (the second database 22) to the user terminal 30 at the subscriber's residence or the first server 10 at the newspaper company (S51).

Then, it is determined whether or not the contract is a fixed-rate contract (S52). If it is not a fixed-rate contract, the previous billing data is referenced (S53), after which a rate according to the last amount of information provided is added to the previous billing data (S54). If it is determined that the contract is a fixed-rate contract, the process directly ends.

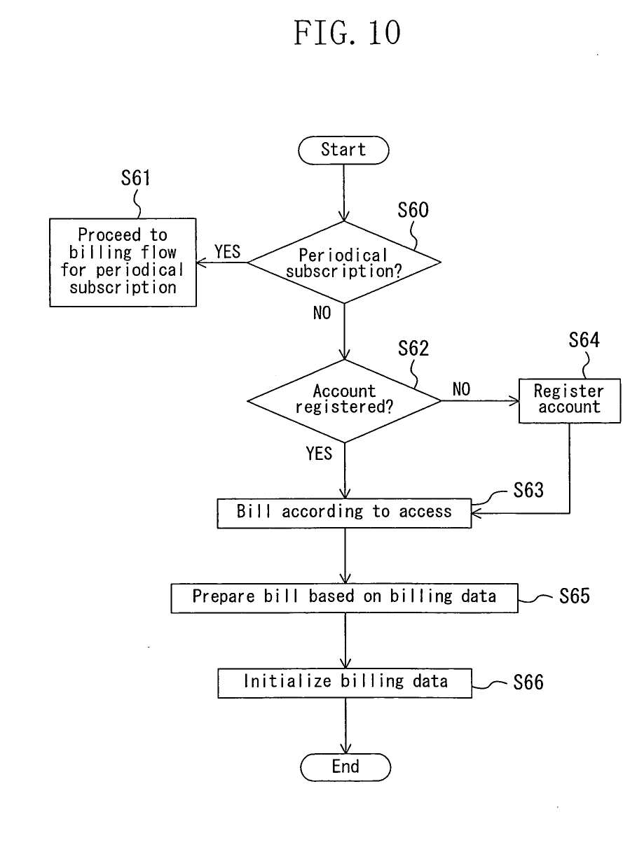

The description so far has been directed primarily to billing methods where the subscription is a periodical subscription. FIG. 10 illustrates the flow of an example of a billing method where the subscription is a non-periodical subscription.

After multimedia information is provided to the user, it is first determined whether or not the subscription is a periodical subscription (S60). If it is a periodical subscription, the process proceeds to a billing flow for a periodical subscription as illustrated in FIG. 6 (S61). If it is not a periodical subscription, i.e., if it is a non-periodical subscription, it is determined whether or not an account of the subscriber has been registered (S62). If an account has been registered, it is billed according to the access made by the subscriber (S63). An “account” as used herein refers to one that is opened at a financial institution, or the like, and to which a rate can be charged, e.g., a bank account. If an account has not been registered, billing is done after an account is registered (S64).

The methods of billing according to the access may be, for example, billing according to the amount of data in the multimedia information provided for each access, billing according to the number of times access is made, or billing according to the contents/type of the information content. After billing according to the access, a bill is prepared based on the billing data (S65), after which the billing data is initialized (S66).

The description so far has been directed to a case where the first server 10 is owned by a newspaper company, the second server 20 is owned by a television station, and the user terminal 30 is owned by a newspaper subscriber, wherein multimedia information according to page information (a news article, etc.) of a newspaper is provided. Of course, the present invention is not limited to this.

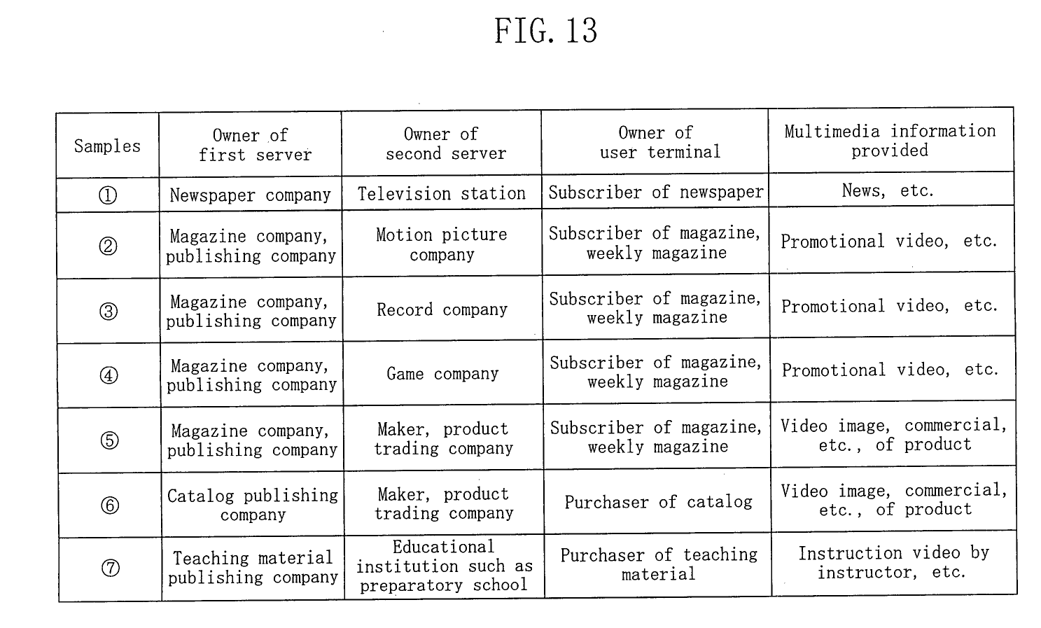

FIG. 13 shows samples of combinations of owners of the first server 10, the second server 20 and the user terminal 30, and types of multimedia information.

As already described above, Sample (1) is a case where the first server 10 is owned by a newspaper company, the second server 20 is owned by a television station, and the user terminal 30 is owned by a newspaper subscriber, wherein news, or the like, is provided.

Samples (2), (3), (4) and (5) are cases where the first server 10 is owned by a magazine company or a publishing company publishing a magazine or a weekly magazine, and the user terminal 30 is owned by a subscriber of the magazine or the weekly magazine.

In Sample (2), the second server 20 is owned by a motion picture company, and multimedia information relating to a motion picture appearing on the magazine or the weekly magazine (e.g., a promotional video thereof) is provided to the subscriber.

In Sample (3), the second server 20 is owned by a record company, and multimedia information relating to a CD or a music video appearing on the magazine or the weekly magazine (e.g., a promotional video thereof) is provided to the subscriber.

In Sample (4), the second server 20 is owned by a game company, and multimedia information relating to a game appearing on the magazine or the weekly magazine (e.g., a promotional video thereof) is provided to the subscriber.

In Sample (5), the second server 20 is owned by a product maker or a product trading company, and multimedia information relating to a product appearing on the magazine or the weekly magazine (e.g., a video image or a commercial of the product) is provided to the subscriber.

Sample (6) is a case where the first server 10 is owned by a catalog publishing company publishing catalogs, etc., and the second server 20 is owned by a product maker or a product trading company that makes or trades a product appearing on a catalog. In this case, the user terminal is owned by a purchaser of the catalog, and multimedia information relating to a product appearing on the catalog (e.g., a video image or a commercial of the product) is provided to the purchaser of the catalog.

Sample (7) is a case where the first server 10 is owned by a teaching material publishing company publishing a textbook, a reference book, etc., and the second server 20 is owned by an educational institution such as a preparatory school. In this case, the user terminal is owned by a purchaser of a teaching material, and multimedia information relating to the contents of the teaching material (e.g., an instruction video by an instructor of the educational institution) is provided to the purchaser of the teaching material.

User Terminal

A preferred embodiment of the user terminal 30 for reading page information and displaying multimedia information will be described.

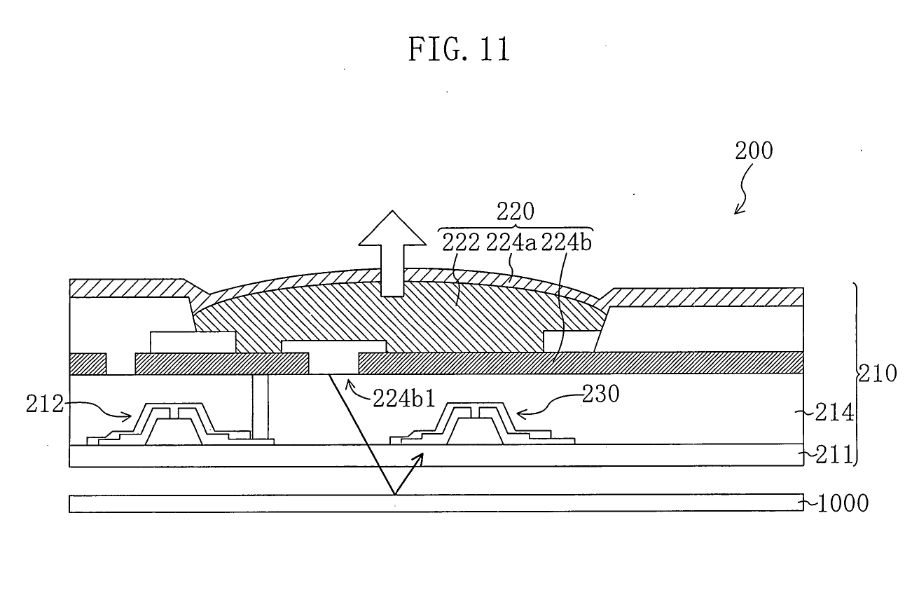

A display device 200 illustrated in FIG. 11 has both a display function of a display device and a image reading function of a scanner, and can suitably be used as the user terminal 30.

The structure of the display device 200 will now be described with reference to FIG. 11. The display device 200 includes a plurality of pixels, and FIG. 11 is a cross-sectional view schematically illustrating a portion corresponding to one pixel of the display device 200. The plurality of pixels are typically arranged in a matrix pattern.

The display device 200 includes a display panel 210, including an organic EL element 220 as a light-emitting element for each of the plurality of pixels and a light-receiving element 230 provided for each of the plurality of pixels. Note that while the light-emitting element herein is an organic EL element, it may alternatively be an inorganic EL element or an electrochemical light-emitting element.

The display panel 210 displays an image by using light emitted from the organic EL element 220 toward the front side of the panel (toward the viewer: in the upward direction in FIG. 11).

The light-receiving element 230 receives a portion of light emitted from the organic EL element 220 toward the rear side of the panel (away from the viewer: in the downward direction in FIG. 11) that is reflected by an illuminated object (e.g., a display medium such as a printed matter) 1000 provided on the rear side of the panel.

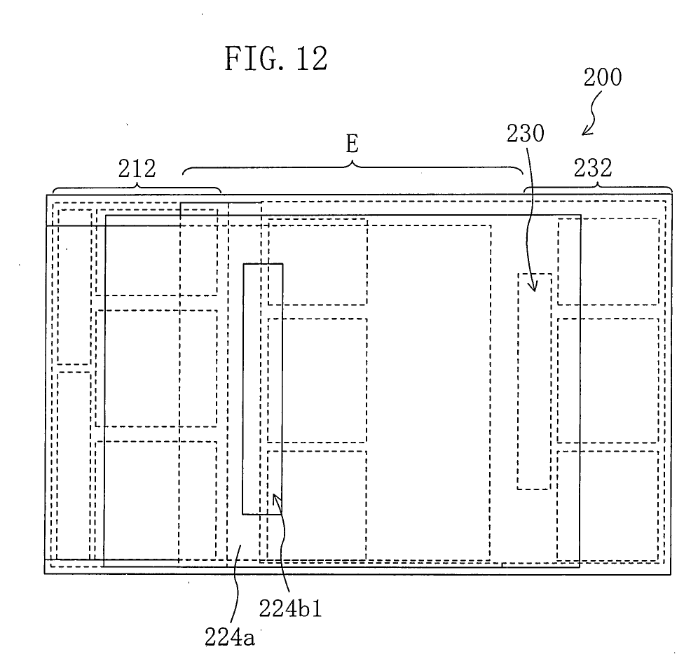

The structure of the display device 200 will now be described in greater detail with reference to FIG. 11 and FIG. 12. FIG. 12 is a plan view schematically illustrating a portion corresponding to one pixel of the display device 200.

In the present embodiment, the display panel 210 of the display device 200 is an active matrix type display panel including a substrate (e.g., glass substrate) 211, and a light emission control section 212 provided on the substrate 211 for controlling the light emission from the organic EL element 220. In a case where an organic EL element is used as a light-emitting element, the light emission control section 212 provided for each of the plurality of pixels typically includes a plurality of switching elements (e.g., TFTs) and a capacitor.

Moreover, the organic EL element 220 and the light-receiving element 230 are also provided on the substrate 211. The light emission control section 212, the organic EL element 220 and the light-receiving element 230 described above are provided on the rear side (away from the viewer) of the substrate 211. Furthermore, a control circuit 232 connected to the light-receiving element 230 is provided on the substrate 211 for each of the plurality of pixels. The control circuit 232 typically has a function of reading out a signal, a function of amplifying a readout signal, and a function of resetting an element for amplifying a signal, and includes, for example, a read transistor for reading out a signal, an amplification transistor for amplifying the readout signal, a reset transistor for resetting the amplification transistor, an addressing transistor, etc.

The organic EL element 220 includes a light-emitting layer 222 and a pair of electrodes 224a and 224b interposing the light-emitting layer 222 therebetween. The electrode 224a, one of the pair of electrodes 224a and 224b that is provided closer to the viewer, is made of a transparent conductive material (e.g., ITO) and electrically connected to the light emission control section 212, and functions as an anode. Moreover, the electrode 224b provided on the rear side is typically made of a metal (e.g., Ca and Ag), and functions as a cathode. The light-emitting layer 222 emits light according to the level of the current supplied to the organic EL element 220 via the light emission control section 212.

In the display device 200, the organic EL element 220 as a light-emitting element, the light emission control section 212, the light-receiving element 230 and the control circuit 232 are provided on the viewer side of the substrate 211. More specifically, the light emission control section 212, the light-receiving element 230 and the control circuit 232 are provided on the viewer-side surface of the substrate 211, and a flattening layer 214 is formed so as to cover these elements. The organic EL element 220 is provided on the flattening layer 214.

The display device 200 is a so-called “top-emission type” organic EL display device that draws light for displaying an image toward the side away from the substrate 211. The anode 224a provided on the viewer side (the front side of the panel) with respect to the light-emitting layer 222 is made of a transparent conductive material, whereby light emitted from the light-emitting layer 222 is output toward the viewer and used for displaying an image. Moreover, the cathode 224b provided on the rear side with respect to the light-emitting layer 222 includes an opening 224b1, and a portion of light emitted from the light-emitting layer 222 is output toward the rear side through the opening 224b1 to illuminate the illuminated object 1000. Since the display device 200 is a top-emission type display device, it is possible to employ a structure where the organic EL element 220 is placed over the light emission control section 212, etc. Therefore, it is possible to improve the aperture ratio over a bottom-emission type display device, thus realizing a higher brightness and a higher definition.

The light-receiving element 230 receives light reflected by the illuminated object 1000, and detects the intensity thereof. The light-receiving element 230 is, for example, a photodiode.

The organic EL element 220 and the light emission control section 212 of the display device 200 can be produced by using a known method for producing an organic EL display device. Moreover, the control circuit 232 connected to the light-receiving element 230 and the light-receiving element 230 can also be produced by using a known production method. In the configuration where an active matrix type display panel 210 is used as in the present embodiment, the light-receiving element 230 and the control circuit 232 can be formed on the substrate 211, on which the light emission control section 212 of the display panel 210 is formed, by using a process similar to that for forming the light emission control section 212. Thus, it is no longer necessary to later implement the light-receiving element 230 and the control circuit 232 on the display panel 210 or to provide lines for routing, whereby it is possible to reduce the power consumption and to suppress the increase in the cost. Moreover, in a case where an active matrix type display panel 210 is used, it is possible to suitably produce a monolithic substrate 211 in which the light emission control section 212, the light-receiving element 230, the control circuit 232, etc., are formed, by using a polysilicon layer having a high electron mobility or a continuous grain silicon (CGS) layer as a semiconductor layer.

The operation of the display device 200 will now be described. The display device 200 is capable of not only displaying image information but also reading image information.

First, the operation of displaying image information will be described. An image is displayed as the organic EL element 220 provided for each pixel emits light at a predetermined intensity. In this process, a light-emitting region E illustrated in FIG. 12 contributes to the display operation. In the present embodiment, the organic EL element 220 is driven in an active matrix driving method by the light emission control section 212 provided for each pixel.

Next, the operation of reading image information will be described. The organic EL element 220 emits light to illuminate the illuminated object 1000 placed on the rear side of the panel. The light-receiving element 230 provided for each pixel receives the light reflected by the illuminated object 1000 and detects the intensity thereof, thereby reading the image information of the surface of the illuminated object 1000. If light-emitting elements emitting different colors of light (e.g., organic EL elements emitting red light, green light and blue light) are provided as the light-emitting elements, it is possible to read color information of the surface of the illuminated object 1000, whereby it is possible to read image information as color image information (colored image information).

The display device 200 includes a light-emitting element (the organic EL element 220 in the illustrated example) for emitting light for displaying an image toward the front side of the panel (toward the viewer) while emitting light toward an illuminated object on the rear side of the panel (away from the viewer), and the light-receiving element 230 for receiving light reflected by the illuminated object, whereby it is possible not only to display an image but also to read image information of the surface of the illuminated object. In other words, the display device 200 has both a function as a planar display device and a function as a planar scanner. Thus, the display device 200 has both a function of scanning a page to read page information as image information, i.e., a function as a reading section, and a function of displaying image information (multimedia information), i.e., a function as a display section, and can be used as the user terminal 30 of the multimedia information provision system 100. It typically further has a structure functioning as a transmission/reception section, and it may further include a structure functioning as a storage section or an output section, as necessary.

Moreover, in the display device 200, the display panel 210 has both a function of displaying an image and a function of reading an image, and the light used for displaying an image and the light used for reading an image are emitted from a common light-emitting element. Thus, with a simple, thin and light-weight structure, it is capable of both displaying and reading image information.

Note that while a user terminal having a mechanically-integrated structure has been described as a preferred embodiment of the user terminal 30, the user terminal 30 does not need to be mechanically integrated, but may alternatively include, for example, a reading section and a display section, separate from each other, that cooperatively function as the user terminal 30.

### INDUSTRIAL APPLICABILITY

As described above, the multimedia information provision system and the multimedia information provision method of the present invention are useful for a system and a method for providing, to a reader of a text information medium such as a newspaper, multimedia information relating to an article thereof, and are particularly suitable for suppressing the capacity of a database for multimedia information associated with page information to be small.

1. A multimedia information provision system, comprising a first server, a second server, and a user terminal connected to one another via an information communication network, for providing, to the user terminal, multimedia information associated with page information input to the user terminal, wherein:
the user terminal includes a reading section for reading page information from a page;
the first server includes a first database storing page information addresses associated with page information, and a retrieval section for retrieving, from the first database, a page information address associated with the page information that has been read by the reading section and transmitted from the user terminal; and
the second server includes a second database storing multimedia information associated with the page information addresses stored in the first database, and transmits, from the second database to the user terminal, multimedia information associated with the page information address that has been retrieved by the retrieval section and transmitted from the first server.

2. The multimedia information provision system of claim 1, wherein the first server further includes an analysis section for analyzing the page information transmitted from the user terminal to obtain text information, and the retrieval section retrieves the page information address based on the text information obtained by the analysis section.

3. The multimedia information provision system of claim 1, wherein the user terminal includes a display section for displaying the multimedia information transmitted from the second server.

4. The multimedia information provision system of claim 1, wherein the reading section provided in the user terminal is a scanner for scanning the page to read the page information as image information.

5. The multimedia information provision system of claim 1, wherein:
the first server is owned by a newspaper company, the second server is owned by a television station, and the user terminal is owned by a newspaper subscriber; and
the reading section provided in the user terminal reads the page information from a page of a newspaper.

6. The multimedia information provision system of claim 1, wherein the user terminal includes a storage section for saving the multimedia information transmitted from the second server.

7. The multimedia information provision system of claim 1, wherein the user terminal includes an output section for externally outputting the multimedia information transmitted from the second server.

8. The multimedia information provision system of claim 1, wherein the second server transmits, from the second database to the first server, the multimedia information associated with the page information address retrieved by the retrieval section of the first server.

9. The multimedia information provision system of claim 1, wherein the multimedia information stored in the second database of the second server includes image information and/or audio information.

10. A multimedia information provision system, comprising a first server, a second server and a user terminal connected to one another via an information communication network, for providing multimedia information associated with a newspaper article read by the user terminal to the user terminal, wherein:
the user terminal includes a scanner for scanning a page of a newspaper to read image information of the newspaper article;
the first server includes an article address database storing article addresses associated with newspaper articles, an analysis section for analyzing the image information that has been read by the scanner and transmitted from the user terminal to obtain text information, and a retrieval section for retrieving, from the article address database, an article address based on the text information obtained by the analysis section;
the second server includes a multimedia information database storing multimedia information associated with the article addresses stored in the article address database, and transmits, from the multimedia information database to the user terminal, multimedia information associated with the article address that has been retrieved by the retrieval section and transmitted from the first server; and
the user terminal further includes a display section for displaying the multimedia information transmitted from the second server.

11. The multimedia information provision system of claim 10, wherein the first server is owned by a newspaper company, the second server is owned by a television station, and the user terminal is owned by a newspaper subscriber.

12. The multimedia information provision system of claim 10, wherein the multimedia information stored in the multimedia information database of the second server includes image information and/or audio information.

13. The multimedia information provision system of claim 1, wherein:
the user terminal includes a transmission/reception section for transmitting/receiving information to/from the first server and the second server;
the first server includes a transmission/reception section for transmitting/receiving information to/from the user terminal and the second server; and
the second server includes a transmission/reception section for transmitting/receiving information to/from the user terminal and the first server.

14. A multimedia information provision method, using a first server, a second server and a user terminal connected to one another via an information communication network, for providing, to the user terminal, multimedia information associated with page information input to the user terminal, the method comprising:
a reading step of reading page information from a page, at the user terminal;
a retrieval step of retrieving, from a first database storing page information addresses associated with page information, a page information address associated with the page information that has been read in the reading step, at the first server; and
a multimedia information transmission step of transmitting, from a second database storing multimedia information associated with the page information addresses stored in the first database to the user terminal, multimedia information associated with the page information address that has been retrieved in the retrieval step, at the second server.

15. The multimedia information provision method of claim 14, wherein:
the method further comprises an analysis step of analyzing the page information that has been read in the reading step to obtain text information, at the first server; and
a page information address is retrieved based on the text information obtained in the analysis step in the retrieval step.

16. The multimedia information provision method of claim 14, further comprising a display step of displaying the multimedia information transmitted from the second server, at the user terminal.

17. A user terminal connected to a main server and an associated server via an information communication network, comprising:
a reading section for reading page information from a page;
a transmission section for transmitting page information that has been read by the reading section to the main server; and
a reception section for receiving multimedia information from the associated server, wherein:
the main server includes a first database storing page information addresses associated with page information and a retrieval section for retrieving, from the first database, a page information address associated with the page information that has been transmitted from the transmission section,
the associated server includes a second database storing multimedia information associated with the page information addresses stored in the first database and transmits to the reception section multimedia information associated with the page information address that has been retrieved by the retrieval section.

18. A main server connected to a user terminal and an associated server via an information communication network, the user terminal including a reading section for reading page information from a page, the main server comprising:
a first database storing page information addresses associated with page information;
a reception section for receiving page information that has been read from a page by the reading section;
a retrieval section for retrieving, from the first database, a page information address associated with the page information that has been received by the reception section; and
a transmission section for transmitting to the associated server the page information address that has been retrieved by the retrieval section, wherein:
the associated server includes a second database storing multimedia information associated with the page information addresses stored in the first database and transmits to the user terminal multimedia information associated with the page information address that has been transmitted from the transmission section.

19. An associated server connected to a user terminal and a main server via an information communication network, the user terminal including a reading section for reading page information from a page, the main server including a first database storing page information addresses associated with page information and a retrieval section for retrieving, from the first database, a page information address associated with the page information that has been read from a page by the reading section, the associated server comprising:
a second data base storing multimedia information associated with the page information addresses stored in the first database;
a reception section for receiving the page information address that has been retrieved by the retrieval section; and
a transmission section for transmitting to the user terminal multimedia information associated with the page information address that has been received by the reception section.

20. The multimedia information provision system of claim 10, wherein:
the user terminal includes a transmission/reception section for transmitting/receiving information to/from the first server and the second server;
the first server includes a transmission/reception section for transmitting/receiving information to/from the user terminal and the second server; and
the second server includes a transmission/reception section for transmitting/receiving information to/from the user terminal and the first server.
